(19) United States
(12) Patent Application Publication
(10) Pub. No.: US 2005/0180050 A1
(43) Pub. Date: Aug. 18, 2005

(54) Tape guide device for magnetic recording and reproducing apparatus

(75) Inventor: Young-ho Cho, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/014,690

(22) Filed: Dec. 20, 2004

(30) Foreign Application Priority Data
Dec. 23, 2003 (KR) 2003-95759

(51) Int. Cl. G11B 5/027

(52) U.S. Cl. 360/130.23

(57) ABSTRACT

A tape guide device for a magnetic recording and reproducing apparatus includes a pole member having a circumferential surface that contacts the magnetic tape when the magnetic tape runs to divert the running direction of the magnetic tape. A base member supports the pole member, and a bottom edge guide member extends from a top surface of the base member. The bottom guide has a top surface adapted to contact the bottom edge of the magnetic tape when the magnetic tape is moved toward the bottom end of the pole member. Since separately provided members for aligning the top and bottom positions of the magnetic tape, such as an impedance roller and a guide roller of the prior art, are not needed, construction of the tape guide device is simplified.

### CROSS-REFERENCE TO RELATED APPLICATIONS

This application claims the benefit under 35 U.S.C. § 119(a) of Korean Patent Application No. 2003-95759 filed Dec. 23, 2004 in the Korean Intellectual Property Office, the entire disclosure of which is hereby incorporated by reference.

### BACKGROUND OF THE INVENTION

1. Field of the Invention

The present invention relates to a magnetic recording and reproducing apparatus. More particularly, the present invention relates to a tape guide device for guiding a magnetic tape running within a deck, thereby forming a magnetic tape running route.

2. Description of the Related Art

Typically, a magnetic recording and reproducing apparatus having a deck mechanism, such as a video tape recorder (VTR) or a camcorder, is an apparatus for recording data into and reproducing data from a magnetic tape while the magnetic tape is running along a predetermined route formed within the deck.

FIG. 1 shows a deck typically employed in a camcorder among magnetic recording and reproducing apparatuses as described above. A conventional deck 100 includes a deck chassis 10, a head drum 30, and a tape guide device 20.

The deck chassis 10 forms the outer wall of the deck 100 and various driving components, such as the head drum 30, the tape guide device 20, etc., which are disposed in the deck chassis 10, for recording and reproducing magnetic data.

The head drum 30 records data onto a magnetic tape 1 running within the deck 10 or reproduces the data recorded in the magnetic tape 1. Such a head drum 30 is installed to be slanted with respect to the bottom surface of the deck chassis 10 as is well-known in the art, so that recording and reproducing data can be efficiently implemented.

The tape guide device 20 draws the magnetic tape 1 out of a tape cassette 90 at the time of loading the magnetic tape 1 and guides the magnetic tape I in such a manner that the magnetic tape 1 comes into close contact with the head drum 30 while the magnetic tape is running. Such a conventional tape guide device 20 includes a pair of pole base assemblies 50 and a tension adjusting unit 40. In the drawing, reference numerals 60, 70 and 80 respectively indicate other components beyond the pole base assemblies 50 and the tension adjusting units 40 in the tape guide device, that is, a pinch roller 60, a review pole assembly 80 and a capstan driving unit 70.

The conventional tension adjusting unit 40 includes a tension arm 41, a tension pole 42, and an impedance roller 43, as shown in FIG. 2. The tension arm 41 is pivotally installed on the deck chassis 10, so that its tip end is pivoted in the direction indicated by arrow A in FIG. 1 toward the outer wall of the deck chassis 10 at the time of loading the magnetic tape. The tension pole 42 extends from the top surface of the tension arm 41 and moves with the magnetic tape 1 contacting the tension pole 42 at the time of loading the magnetic tape 1, thereby drawing the magnetic tape 1 out of the tape cassette 90. When the magnetic tape 1 runs after the completion of loading of the magnetic tape 1, the tension pole 42 draws the magnetic tape in the direction opposite to the running direction T of the magnetic tape 1, thereby giving tension, so-called back tension, to the magnetic tape 1. The tension is adjusted by a tension arm moved within a predetermined range in cooperation with a brake means (not shown) provided in a tape reel 15 in a supply reel side. Because such a technology is generally employed and well-known in the art, the description thereof is omitted herein. Meanwhile, the tension pole 42 also provides a function of diverting the running direction of the magnetic tape 1 to the pole base assembly 50 side when the magnetic tape 1 runs in addition to giving tension to the magnetic tape 1 as described above. In addition, the impedance roller 43 serves to align the top and bottom positions of the magnetic tape 1 after the running direction of the magnetic tape has been diverted by the tension pole 42. The impedance roller 43 comprises upper and lower flanges 44 and 45 contacting the upper and bottom edges of the magnetic tape 1, respectively.

Each of the conventional pole base assemblies 50 include a pole base member 51, a guide pole 53, and a guide roller 55. A pair of pole base assemblies 50 are installed on the deck chassis 10 to correspond the left and right sides of the head drum 30, respectively, and the pole base assemblies 50 are moved to the loading positions P2 (see FIG. 1) adjacent to the head drum 30 along guide rails 11 at the time of loading the magnetic tape 1. The guide pole 53 and the guide roller 55 are provided on the pole base member 51 extend from the top surface of the pole base member 51 and move in contact with the magnetic tape at the time of loading the magnetic tape 1, thereby urging the magnetic tape 1 to come into close contact with the head drum 30. If the magnetic tape 1 runs after the loading of the magnetic tape 1 has been completed, they guide the running of the magnetic tape 1 in such a manner that the magnetic tape 1 runs in close contact with the head drum 30. Here, the guide pole 53 is installed parallel to the circumferential surface of the head drum 30 and slanted with respect to the bottom surface of the deck when the loading of the magnetic tape 1 has been completed. The running direction of the magnetic tape 1 is diverted to the head drum 30 side by such a guide pole 53. In addition, the guide roller 55 serves to align the top and bottom positions of the magnetic tape 1 entering into the guide pole 53 and includes upper and lower flanges 57 and 56 contacting the top and bottom edges of the magnetic tape 1, respectively.

The conventional deck 100 described above typically has all of the pole members 42, 53 and rollers 43, 55 on each of the pole base members 50 and the tension adjusting unit 40. Therefore, there is a problem in that it is not easy to reduce the manufacturing costs and steps for such a magnetic recording and reproducing apparatus. In addition, there is also a problem in that it is difficult to miniaturize such a magnetic recording/reproducing apparatus.

### SUMMARY OF THE INVENTION

Accordingly, the present invention has been made to solve the above-mentioned problems. An object of the present invention is to provide a tape guide device for a magnetic recording and reproducing apparatus that has reduced manufacturing costs, fewer manufacturing steps for the magnetic recording and reproducing apparatus and miniaturizing the magnetic recording and reproducing apparatus.

A tape guide device for a magnetic recording and reproducing apparatus includes a pole member having a circumferential surface coming into contact with the magnetic tape while the magnetic tape is running to divert the running direction of the magnetic tape. A base member supports the pole member. A bottom edge guide member extends from a top surface of the base member, and the bottom guide having a top surface coming into contact with the bottom edge of the magnetic tape when the magnetic tape contacts the circumferential surface of the pole member and is moved toward the bottom end of the pole member.

According to a preferred embodiment of the present invention, the tape guide device includes a top edge guide member disposed at the top end of the pole member. The top edge guide member has a bottom surface adapted to contact the top edge of the magnetic tape when the magnetic tape is moved toward the top end of the pole member.

This arrangement simplifies the construction of the deck because it is not needed to separately provide members, such as an impedance roller and a guide roller of the prior art, to align the top and bottom positions of the magnetic tape.

According to another preferred embodiment of the present invention, the base member is a tension arm pivotably installed on the deck to pivot in response to loading and unloading of the magnetic tape. The pole member is a tension pole installed on the top of the tension arm and is adapted to be moved in response to the pivot of the tension arm at the time of loading the magnetic tape to draw the magnetic tape toward an inner wall of the deck at the time when the magnetic tape runs. The bottom edge guide member is a first guide member extending from a top surface of the tension arm. The top edge guide member is a second guide member extending in the diametric direction of the tension pole from the top end of the tension pole, so that the outer diameter is increased.

According to another preferred embodiment of the present invention, the base member is a pole base member installed on the deck and is adapted to be movable toward and away from the head drum angularly installed on the deck and moving toward the head drum at the-time of loading the magnetic tape. The pole member is a guide member moved to a loading position adjacent to the head drum by the pole base member at the time of loading the magnetic tape, in which the guide member is angularly installed on the top surface of the pole base member so that the circumferential surface of guide pole is parallel to the circumferential surface of the head drum when the loading of the magnetic tape has been completed. The bottom edge guide member is a third guide member extending from a top surface of the pole base member.

In another embodiment, the top edge guide member is a fourth guide member disposed at the top end of the guide pole. A bottom surface is adapted to contact the top edge of the magnetic tape when the magnetic tape is moved toward the top end of the guide pole. The bottom surface of the fourth guide member is formed to be angled with respect to the circumferential surface of the guide pole in which the bottom surface is parallel to the running direction of the magnetic tape in a section where the head drum and the magnetic tape contact each other.

Preferably, the bottom surface of the top edge guide member and the circumferential surface of the pole member are at obtuse angles with each other and the top surface of the bottom edge guide member and the outer surface of the pole member are at obtuse angles with each other.

The bottom edge guide member is preferably integrally formed with the base member. Preferably, the bottom edge guide member and the base member are formed as molded products of synthetic resin.

With this arrangement, the bottom edge guide member may be more easily formed.

### BRIEF DESCRIPTION OF THE DRAWINGS

The above and other objects and features of the present invention will be more apparent from the description of exemplary embodiments of the present invention taken with reference to the accompanying drawings, in which:

FIG. 1 is a top plan view schematically showing a conventional deck of a magnetic recording and reproducing apparatus;

FIG. 2 is a side view showing the tension adjusting unit of FIG. 1 developed along a running route of a magnetic tape;

FIG. 3 is a partial perspective view showing the pole base assembly and the head drum extracted from FIG. 1;

FIG. 4 is a perspective view schematically showing the interior of a deck according to an embodiment of the present invention;

FIG. 5 is a partial perspective view of the tension adjusting unit extracted from FIG. 4;

FIG. 6 is a side elevational view of the operating state of the tension adjusting unit of FIG. 4;

FIG. 7 is an exploded perspective view of the pole base assembly of FIG. 4;

FIG. 8 is a schematic view of the operating state of the pole base assembly along the running route of a magnetic tape; and

FIG. 9 is a side elevational view of a pole base assembly according to another embodiment of the present invention.

Throughout the drawings, like reference numerals will be understood to refer to like parts, components and structures.

### DETAILED DESCRIPTION OF THE PREFERRED EMBODIMENTS

The matters defined in the description, such as a detailed construction and elements thereof, are provided to assist in a comprehensive understanding of the invention. Thus, it is apparent that the present invention may be carried out without those defined matters. Also, well-known functions or constructions are not described in detail since they would unnecessarily obscure the description of the preferred embodiments.

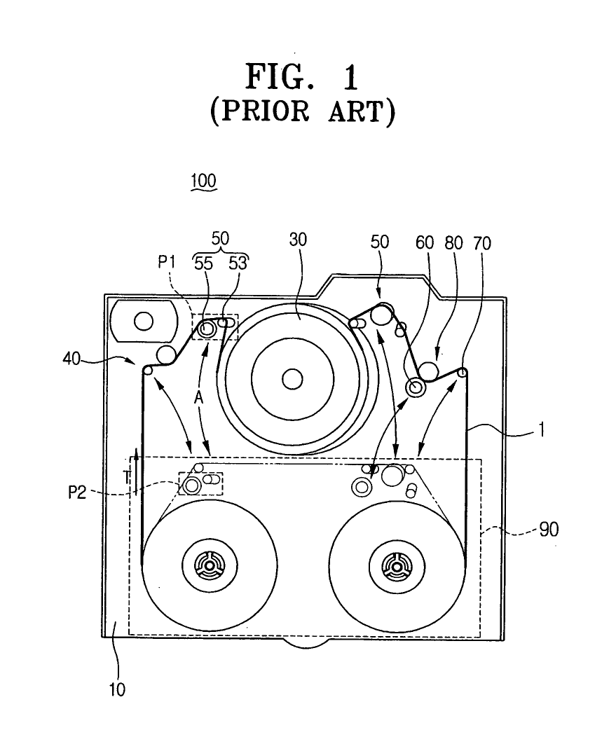

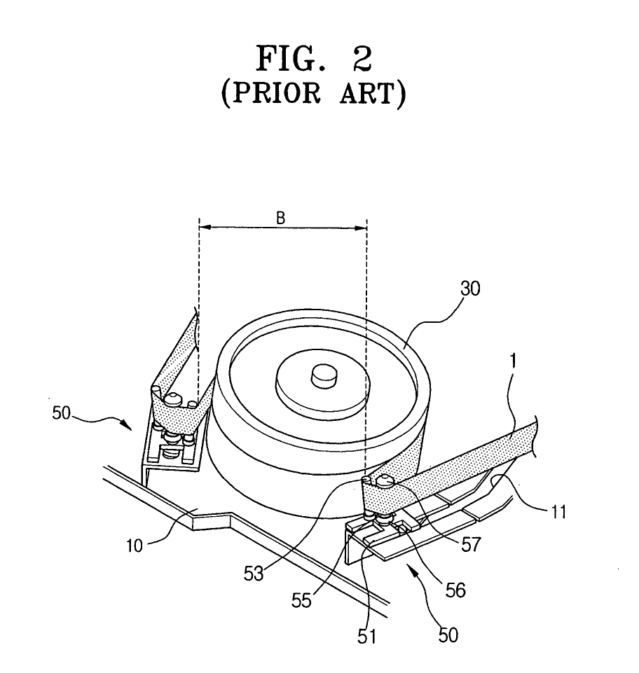

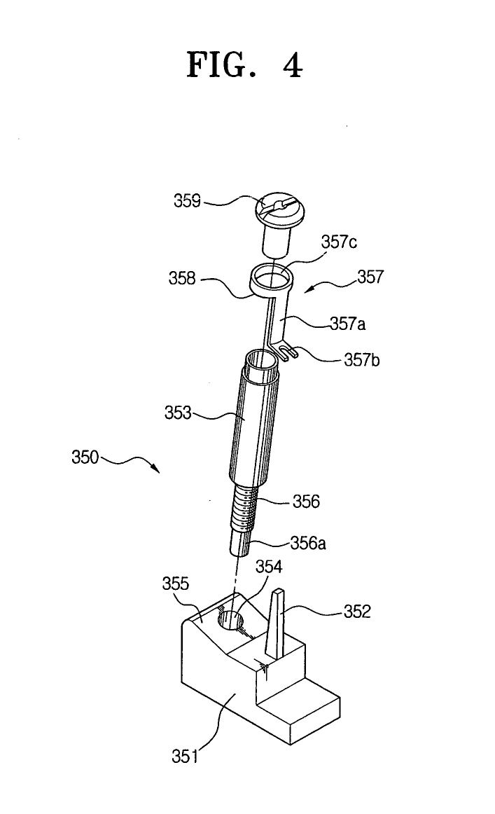

Referring to FIG. 4, a deck 200 of a magnetic recording and reproducing apparatus according to a preferred embodiment of the present invention includes a deck chassis 10 and a tape guide device 300. The tape guide device 300 includes a tension adjusting unit 310 without a conventional impedance roller (indicated by reference numeral 43 in FIG. 1), and a pole base assembly 350 without a conventional guide roller (indicated by reference numeral 44 in FIG. 1).

Since this arrangement omits the conventional impedance and guide rollers, the number of components required at the time of manufacturing a deck 200 may be reduced.

Each of the pole base assemblies 350 and the tension adjusting unit 310 of the tape guide device 300 according to an embodiment of the present invention include a base member 311 and 351 pivotably or movably mounted on the deck chassis 10, a pole member 313 and 353 installed on the base member 311 and 351 at an angle thereto, a top edge guide member 318 and 357 disposed at a top end of the guide member 313 and 353, and a bottom edge guide member 315 and 355 disposed at the bottom end of the guide member 313 and 353.

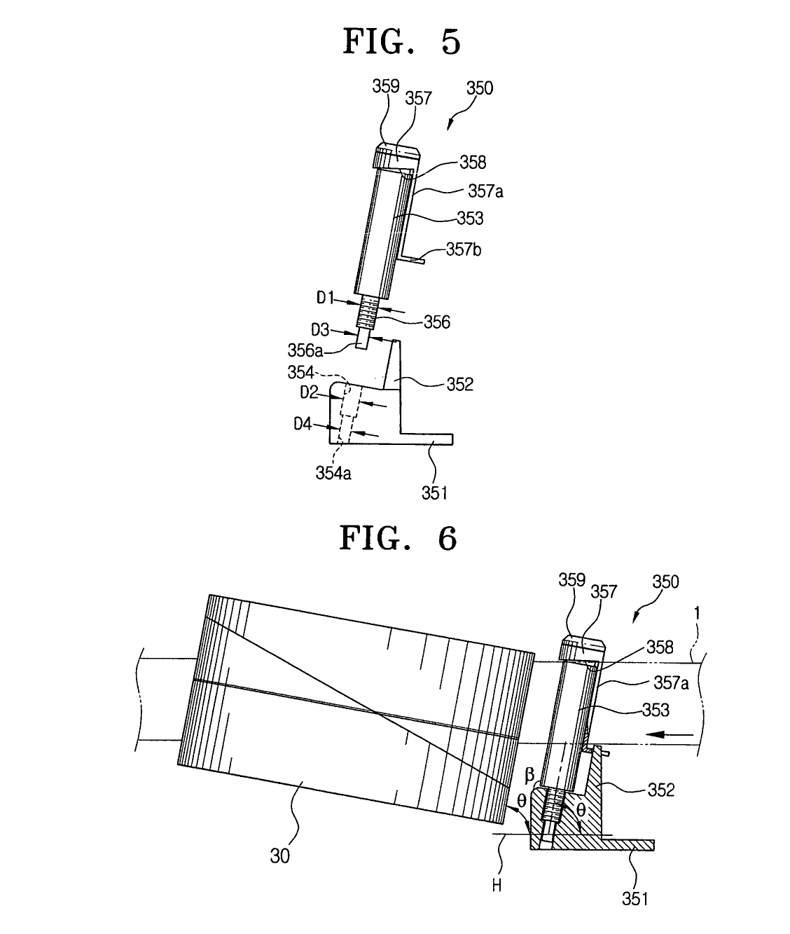

As shown in FIGS. 5 and 6, the tension adjusting unit 310 according to an embodiment includes a tension arm 311 as the base member, and a tension pole 313 as the pole member.

The tension pole 313 is moved to a predetermined loading position P1 (see FIG. 1) as the tension arm 311 pivots at the time of loading a magnetic tape 1 and draws the magnetic tape out of a tape cassette 90 (see FIG. 1). In addition, the tension pole 313 comes into contact with the magnetic tape 1 when the magnetic tape 1 runs to divert the running direction of the magnetic tape so that the magnetic tape 1 runs toward the pole base assembly 350.

The tension pole 313 is secured at an angle to the top surface of the tension arm 311. The tension arm 311 is installed on the deck chassis 10 to be pivotable about a pivot axis 311a (see FIG. 4). With this arrangement, the tension arm 311 pivots in the direction indicated by arrow A in FIG. 1 to locate the tension pole 313 at the loading position P1 (see FIG. 1) at the time of loading the magnetic tape 1. When the loading of the magnetic tape 1 has been completed, the tension arm 311 is moved within a predetermined range by a supply side reel table 15 (see FIG. 4), thereby adjusting the magnitude of back tension applied to the magnetic tape 1 as in the prior art described above. The angle between the tension pole 313 and the tension arm 311 vary depending on the shape and moving path of the tension arm 311. If the tension arm 311 horizontally pivots in response to loading or unloading of the magnetic tape 1 and the top surface of the tension arm 311 is parallel to the running direction T of the tape running from the tape cassette 90 (see FIG. 1) of the deck chassis 10, preferably the tension pole 313 is substantially perpendicular to the tension arm 311.

The tension adjusting unit 310 includes first and second guide members 315 and 318 corresponding to the top and bottom edge guide members, as shown in FIGS. 5 and 6. The first and second guide members 315 and 318 are provided to make the tension pole 313 perform the function of the conventional impedance roller (indicated by reference numeral 43 in FIG. 1).

The first guide member 315 is disposed at the bottom end of the tension pole 313, and preferably is integrally formed with the tension arm 311 to extend from the top surface of the tension arm 311.

The second guide member 318 is disposed at the top end of the tension pole 313 and is formed by the diametrically expanded top end of the tension pole 313. Preferably, the second guide member 318 is integrally formed with the tension pole 313.

The first and second guide members 315 and 318 are formed in such a shape that the top surface 316 and bottom surface 319 of the first and second guide members 315 and 318 are adapted to contact the top and bottom edges of the magnetic tape 1, respectively, as the magnetic tape 1 is moved toward the top or bottom end of the tension pole at the time when the magnetic tape 1 is loaded or unloaded or while the magnetic tape 1 is running. In this event, the distance between the top surface 316 of the first guide member 315 and the bottom surface 319 of the second guide member 318 is preferably sized so that the top surface 315 and the bottom surface 319 are adapted to contact the magnetic tape, respectively, only when the magnetic tape 1 is moved up and down. According to an embodiment of the present invention, preferably, the bottom surface 319 and the top surface 316 are angularly formed to form an obtuse angle with respect to the circumferential surface of the tension pole, so that the bottom surface 319 and the top surface 316 prevent the magnetic tape 1 from being damaged at the time of being moved and the magnetic tape 1 may return to the normal position thereof by itself. In this event, preferably, a connecting groove 314 is formed between the bottom surface of the second guide member 318 and the tension pole 313. The connecting groove 314 is formed as the outer diameter of the tension pole 313 is reduced, thereby substantially preventing the top end of the second guide member 318 from being unnecessarily raised to secure an angle between the bottom surface 319 of the second guide member 318 and the circumferential surface of the tension pole 313.

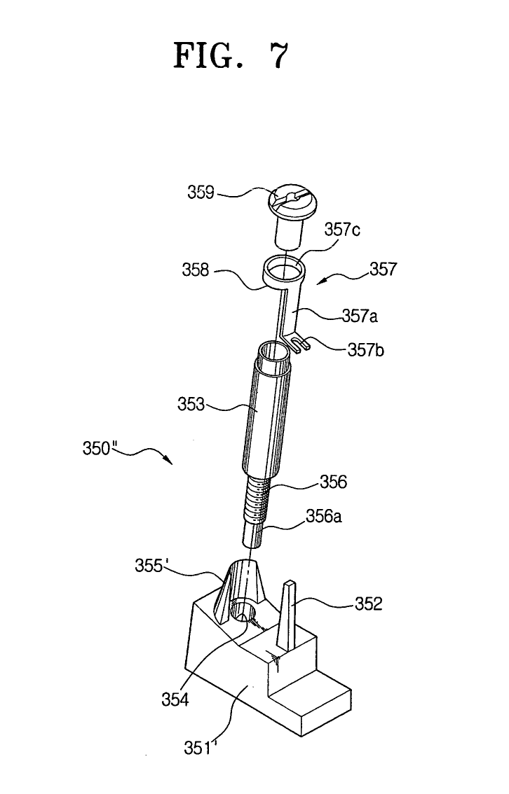

As shown in FIGS. 7 and 8, the pole base assembly 350 includes a pole base member 351 as the base member and a guide pole 353 as the pole member.

A pair of such pole base members 351 are provided on the deck chassis 10 corresponding to the left and right sides of the head drum 30 and moved to the loading positions P2 (see FIG. 1) adjacent to the head drum 30 at the time of loading the magnetic tape 1.

The guide pole 353 is secured to the top surface of the pole base member 351 and moved with the pole base member 351 at the time of loading the magnetic tape 1, thereby urging the magnetic tape 1 to come into close contact with the head drum 30. When the magnetic tape 1 is moved after the completion of the loading of the magnetic tape 1, the guide pole 353 guides the magnetic tape 1 to run in close contact with the head drum 30. Reference numeral 352 indicates a guide projection slidably connected with a guide projection 357a of a fourth guide member 357.

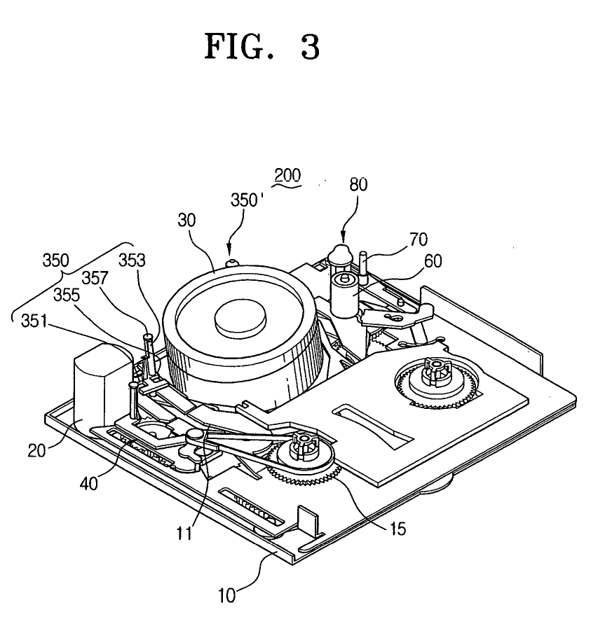

The guide pole 353 of the present embodiment is angularly secured to the top surface of the pole base member 351. The head drum 30 is installed on the deck chassis 10 at an angle with respect to the bottom of the deck chassis 10 and the running of the magnetic tape 1 in the section where the magnetic tape 1 is contacted with the head drum 30 (section B in FIG. 3) is at an angle with respect to the running of the magnetic tape in the other section. Accordingly, when the loading of the magnetic tape 1 has been completed, the guide pole 353 is installed at an angle with respect to the bottom surface of the deck chassis 10 such that the circumferential surface of the guide pole 353 is parallel to a part of the outer surface of the head drum where the contact between the magnetic tape 1 and the head drum 30 is initiated or terminated. The magnitude of the angle between the guide pole 353 and the pole base member 351 may be varied depending on the shape of the guide rail 11 (see FIG. 4) for guiding the movement of the pole base member 351 at the time of loading and unloading the magnetic tape 1. Although not shown in the drawings, if the pole base member 351 is guided by the guide rail 11 in such a manner that the pole base member 351 is moved to an angle corresponding with the head drum 30, preferably the guide pole 353 and the pole base member 351 are substantially perpendicular to each other. Whereas, if the pole base member 351 is moved parallel to the bottom surface of the deck chassis 10 at the time of loading and unloading of the magnetic tape 1 as shown in FIG. 4, the guide pole 353 is angularly installed at an angle θ formed between the deck chassis 10 and the circumferential surface of the head drum 30.

The pole base assembly 350 includes a third guide member 355 corresponding to the bottom edge guide member and a fourth guide member 357 corresponding to the top edge guide member so as to omit the conventional guide roller 55 (see FIG. 1). With the third and fourth guide members 355 and 357, the top and bottom positions of the magnetic tape 1 may be aligned in relation to the head drum 30 such that the contact between the head drum 30 and the magnetic tape 1 may be provided at a predetermined position when the magnetic tape is loaded, unloaded and moved.

The third guide member 355 extends from a top surface of the pole base member 351 and has a top surface 356 adapted to contact the bottom edge of the magnetic tape 1 when the magnetic tape 1 is moved toward the bottom end of the guide pole 353. The top surface 356 is formed in a shape surrounding a part of the bottom end of the guide pole 353 adapted to contact the magnetic tape 1 when the magnetic tape 1 is loaded, unloaded and moved. Preferably, the third guide member 351 is integrally formed with the pole base member 351 to facilitate its fabrication. Preferably, the third guide member 355 and the pole base member 351 are integrally formed as molded products of synthetic resin. Preferably, the third guide member 355 and the outer surface of the guide pole 353 form an obtuse angle therebetween. The first and second guide members 315 and 318 are substantially similar and thus description thereof is omitted herein. Preferably, the internal circumferential surface 355a of the third guide member 355 facing the outer surface of the guide pole 353 is formed in a curved surface to correspond to the contour of the bottom end of the guide pole 353.

The fourth guide member 357 is engaged with the pole base member 351 to surround the top end of the guide pole 353. In addition, the fourth guide member 357 has a bottom surface 358, which comes into contact with the top edge of the magnetic tape moving toward the top end of the guide pole 353. The bottom surface 358 of the fourth guide member 357 is preferably formed parallel to the running direction of the magnetic tape 1 in the section B where the head drum 30 and magnetic tape 1 come into contact with each other (see FIG. 3). The bottom surface of the fourth guide member 357 is preferably angled with respect to the circumferential surface of the guide pole 353 when engaged with the pole base member 351. As described above, the bottom surface of the fourth guide member 357 is not angled over the entire section. That is, as shown in FIG. 8, only a part of the bottom surface to be angled corresponds to a section where the circumferential surface of the guide pole 353 is contacted with the magnetic tape 1 when the magnetic tape 1 is loaded, unloaded and moved. The remaining section except the angled section may take any form unless it causes a problem for the running of the magnetic tape 1 and in configuring the deck 200.

The above-mentioned fourth guide member 357 is engaged with the top end of the guide pole 353 by a coupling member 359. Reference numeral 357a is a guide projection connected to the guide projection 352 formed on the top surface of the pole base member 351 substantially prevents the fourth guide member 357 from being rotated with respect to the guide pole by an external impact.

FIG. 9 shows a pole base assembly according to another embodiment of the present invention. The pole base assembly 350′ of an embodiment of the present invention has a pole base member 351′ having a top surface that is a fourth guide member 355′. Preferably, the guide pole 353 is angled with respect to the bottom surface of the deck chassis 10 even when the magnetic tape 1 is unloaded. In this event, the magnetic tape 1 tends to be moved only toward the top end of the guide pole 353 due to the tension of the magnetic tape 1 at the time of loading and unloading of the magnetic tape 1. Therefore, functional deterioration of the entire pole base assembly 350′ is not caused even if the fourth guide 357 formed by the top surface of the pole base member 351′ is used. With this arrangement, it is possible to form the fourth guide member in a more simple shape. Meanwhile, the other components, except the fourth guide member 357, are substantially similar to those of the previous embodiments. Therefore, description thereof is omitted herein.

In the above, the present invention has been shown and described only in terms of the supply side pole base assembly 350 and tension adjusting unit 310 in the tape guide device 300. However, the present invention is not limited to these. That is, the present invention is applicable to any tape guide device if the device includes a pole member adapted to contact and support a magnetic tape 1, and a base member adapted to move the pole member in response to loading and unloading of the magnetic tape 1. For example, the present invention is also applicable to a tape guide device provided with a pole member like the review pole assembly 70 (see FIG. 1)

In addition, although the present invention is described in terms of a deck of a camcorder by way of an example, the present invention is also applicable to a deck of other magnetic recording and reproducing apparatus such as a video tape recorder VTR if the deck includes a tape guide device provided with a pole member and a base member as described above.

As described above, according to the present invention, a base member or a pole member of the tape guide member is directly provided with top and bottom edge guide members for restraining a magnetic tape to be moved toward the top and bottom ends of the pole member. As a result, conventional members, such as an impedance roller and a guide roller, separately provided for aligning the top and bottom positions of the magnetic tape may be omitted, and thus the running route of the magnetic tape may be simplified. In addition, because the bottom edge guide member is integrally formed with the base member, the base member and bottom edge guide member may be more easily configured. Therefore, it is possible to provide a more slim magnetic recording and reproducing apparatus as well as to reduce the manufacturing costs and steps for a magnetic recording and reproducing apparatus.

While the preferred embodiments of the present invention have been shown and described in order to exemplify the principle of the present invention, the present invention is not limited to the specific embodiments. It will be understood that various modifications and changes can be made by one skilled in the art without departing from the spirit and scope of the invention as defined by the appended claims. Therefore, it shall be considered that such modifications, changes and equivalents thereof are all included within the scope of the present invention.

1. A tape guide device for a magnetic recording and reproducing apparatus to guide a magnetic tape running within a deck, comprising:
a pole member having a circumferential surface adapted to contact the magnetic tape when the magnetic tape runs to divert the running direction of the magnetic tape;
a base member supporting the pole member; and
a bottom edge guide member extending from a top surface of the base member, the bottom edge guide member having a top surface adapted to contact a bottom edge of the magnetic tape when the magnetic tape contacting the circumferential surface of the pole member is moved toward a bottom end of the pole member.

2. A tape guide device as claimed in claim 1, wherein
a top edge guide member provided at a top end of the pole member and having a bottom surface adapted to contact the top edge of the magnetic tape when the magnetic tape is moved toward the top end of the pole member.

3. A tape guide device as claimed in claim 2, wherein
the base member is a tension arm pivotably installed on the deck adapted to pivot in response to loading and unloading of the magnetic tape;
the pole member is a tension pole installed on a top surface of the tension arm adapted to move in response to pivoting of the tension arm at the time of loading the magnetic tape and to draw the magnetic tape toward an inner wall of the deck when the magnetic tape runs;
the bottom edge guide member is a first guide member extending from the top surface of the tension arm; and
the top edge guide member is a second guide member extending in the diametric direction of the tension pole from a top end of the tension pole to increase the outer diameter.

4. A tape guide device as claimed in claim 2, wherein
the base member is a pole base member installed on the deck and adapted to move toward and away from a head drum angularly connected to the deck, the base member moving toward the head drum at the time of loading the magnetic tape;
the pole member is a guide member movable to a loading position adjacent to the head drum by the pole base member at the time of loading the magnetic tape, the guide member being slantly installed on a top surface of the pole base member so that a circumferential surface of the guide pole is parallel to the circumferential surface of the head drum when the loading of the magnetic tape has been completed; and
the bottom edge guide member is a third guide member extending from the top surface of the pole base member.

5. A tape guide device as claimed in claim 4, wherein
the top edge guide member is a fourth guide member disposed at a top end of the guide pole;
the fourth guide member has a bottom surface adapted to contact a top edge of the magnetic tape when the magnetic tape is moved toward the top end of the guide pole; and
a bottom surface of the fourth guide member is angled with respect to the circumferential surface of the guide pole, the bottom surface being parallel to the running direction of the magnetic tape when the head drum and the magnetic tape are in contact.

6. A tape guide device as claimed in claim 2, wherein
the bottom surface of the top edge guide member and the circumferential surface of the pole member form an obtuse angle therebetween.

7. A tape guide device as claimed in claim 1, wherein
the top surface of the bottom edge guide member and the outer surface of the pole member form an obtuse angle therebetween.

8. A tape guide device as claimed in claim 1, wherein
the bottom edge guide member is integrally formed with the base member.

9. A tape guide device as claimed in claim 8, wherein
the bottom edge guide member and the base member are molded products of synthetic resin.

10. A tape guide device as claimed in claim 3, wherein
a groove is formed between the lower surface of the second guide member and the tension pole.

11. A tape guide device for a magnetic recording and reproducing apparatus to guide a magnetic tape running within a deck, comprising:
a tension adjusting unit including
a tension arm pivotally connected to the deck;
a tension pole having a circumferential surface adapted to contact the magnetic tape and being angularly connected to the tension arm;
a first guide member disposed at a bottom end of the tension pole;
a second guide member disposed at a-top end of the tension pole;
a pole base assembly including
a pole base member movably connected to the deck;
a guide pole having a circumferential surface adapted to contact the magnetic tape and being angularly connected to the pole base member;
a third guide member disposed at a bottom end of the guide pole; and
a fourth guide member disposed at a top end of the guide pole.

12. A tape guide device as claimed in claim 11, wherein
a groove is formed between a lower surface of the second guide member and the tension pole.

13. A tape guide device as claimed in claim 11, wherein
an obtuse angle is formed between a bottom surface of the second guide member and the circumferential surface of the tension pole.

14. A tape guide device as claimed in claim 11, wherein
an obtuse angle is formed between a bottom surface of the fourth guide member and the circumferential surface of the guide pole.

15. A tape guide device as claimed in claim 11, wherein
the first guide member and the tension arm are integrally formed.

16. A tape guide device as claimed in claim 15, wherein
the first guide member and the tension arm are molded products of synthetic resin.

17. A tape guide device as claimed in claim 1 1, wherein
the third guide member and the pole base member are integrally formed.

18. A tape guide device as claimed in claim 17, wherein
the third guide member and the pole base member are molded products of synthetic resin.

19. A tape guide device as claimed in claim 11, wherein
a coupling member secures the fourth guide member to the guide pole.

20. A tape guide device as claimed in claim 11, wherein
a guide projection extends from the pole base member and is adapted to engage the fourth guide member to substantially prevent rotation of the fourth guide member with respect to the guide pole.
